(19) United States
(12) Patent Application Publication
(10) Pub. No.: US 2017/0024757 A1
(43) Pub. Date: Jan. 26, 2017

(54) COMPUTER BASED METHOD AND COMPUTER SYSTEM FOR PARTICIPATING IN AN INTERNET LOTTERY DURING A SALES TRANSACTION

(71) Applicants: Christian Nitsch, Dornhan (DE); Daniel Endrikat, Dornhan (DE)

(72) Inventors: Christian Nitsch, Dornhan (DE); Daniel Endrikat, Dornhan (DE)

(21) Appl. No.: 14/804,786

(22) Filed: Jul. 21, 2015

(51) Int. Cl. G06Q 30/02; G06Q 20/10; G06Q 30/04

(52) U.S. Cl. CPC G06Q 30/0212; G06Q 30/04; G06Q 20/10

(57) ABSTRACT

A method for executing a purchase of buyer from a seller, wherein the at least one purchased article is stored in an electronic data base of the seller with an article data set and with an article price on a computer unit and the buyer can receive a bonus from the seller for the purchase wherein the bonus is advantageously determined through a lottery and credited towards a current purchase or a subsequent purchase. Alternatively the bonus can also be granted as a coupon or as a credit. It is a prerequisite for participating in the lottery that at least one commercial message is received and viewed wherein the online marketing platform is networked with the online sales platform. The invention furthermore relates to a computer program product with program code devices for performing the sponsored sales execution.

### FIELD OF THE INVENTION

The invention relates to a method for executing a purchase of a buyer from a seller, wherein the purchased articles are stored in an electronic data base of the seller with an article data set and an article price on a computer device. The invention furthermore relates to a computer readable medium on which a computer program product is stored which includes program code devices which include instructions for controlling the computer system to control and coordinate a sales transaction of a buyer with a seller, wherein the purchased articles are stored in an electronic data base of the seller with an article data set and article price on the computer unit. The invention also relates to a computer system for an online sales platform for executing a purchase of a buyer from a seller and a computer system for an online marketing platform which facilitates directing potential buyers to a particular internet site for executing a purchase transaction with a seller.

### BACKGROUND OF THE INVENTION

For a buyer there are currently two options to purchase articles that are offered by a seller. The purchase can be made in a traditional store or at a more contemporary internet store.

Traditionally the customer physically enters a store in which the articles to be sold are presented and stored in shelfs or on pallets. In contemporary physical stores typically there is at least an electronic cash register system and an electronic inventory management system, wherein the offered articles are stored in an electronic data base of the seller with an article data set and an article price on a computer device and data for generating an invoice is transferred from the computer device into the cash register system. The articles to be sold are advertised in the stores and typically also advertised via print media, thus catalogues, brochures, and similar. Furthermore, the sold articles are often presented and advertised to a buyer through radio and television commercials.

In an internet store, thus a store that offers and sells products over the internet the articles are also stored in an electronic data base of the seller with an article data set and an article price on a computer device. This database provides the information needed to generate the invoice. Internet business where the seller sells the products through an online sales platform or an online store is increasing continuously. In addition to the internet stores internet auction portals which offer products for purchase have become popular. For all these online purchase options the sellers operate internet pages where product groups with price information are published. Thus, the internet user can generate an overview over the plethora of product offerings with a search engine and can order online from the offered products in a quick and simple manner.

Online Internet presentations of corporations or marketing platforms in which current offerings of venders are advertised exist in extremely large numbers. In order to increase market presentation and use of such web sites registered users are offered bonuses or rebates as incentives, either directly in the form of cash or in the form of bonus points or similar and are credited for example by bonus-rebate-agencies like payback. Using advertising online internet presentations which are also designated as online marketing platforms requires an internet connection and a computer device that is connectable with the internet like for example a smart phone, a tablet computer, or a personal computer.

Internet advertising, typically also designated online marketing is marketing which addresses customers, this means potential buyers via the internet via so called email advertising, banner advertising, popup adverting, search engine advertising, and commercial video clips. All these measures are geared to guiding persons to a particular internet presence, this means web sites in which online purchases can be executed or initiated. Thus, online marketing platforms use video commercials quite successfully.

Selling products over the internet is getting more and more popular since it provides great advantages for buyers and also for sellers. A seller reaches a much larger group of buyers than this would be possible with one or plural stores. A buyer can access a very comprehensive product offering from anywhere anytime. Additionally both have the opportunity to compare offers of different vendors with each other directly. In order to complete an online purchase the buyer has to identify himself at the seller during any internet purchase providing his bank connection or mode of payment and his delivery address. Many times the user has to provide additional information and has to set up a buyer profile with the online sales platform or the internet shop of the seller. Alternatively the buyer can also identify himself though an online payment system through which the payment for the purchase shall be effected. These services are thus positioned between buyer and seller. Using these services customers can pay bills online or perform transfers. In order to use an online payment system of this type a customer initially has to set up an account with the operator of the online payment system. When an internet shop supports an online payment system the buyer is directly transferred to the respective website after having selected the payment system. At this website the registered buyer logs in with his username and password selected with the account provider, subsequently selects the mode of payment as far as possible or required and confirms the transaction. In his account payment data like bank accounts or credit card data is stored. Thus, no bank or credit card data is transmitted to the seller, this means the internet shop operator, during the transaction. Thus, this is a particularly safe method of performing a payment for an internet purchase since all data remains with the online payment system. There is already a plethora of online payment systems like e.g. PayPal which are increasingly used in e-commerce due to their secure transactions.

Store purchases and also online internet purchases of a buyer from a seller are typically executed with the following steps.

Selecting at least one article offered by the seller, recording the at least one article selected by the buyer, capturing a purchase completion report which indicates completion of the purchase, at least temporary storage of an article data set associated with the at least one selected article with article price and total article billing amount resulting there from for the purchased articles in a purchase data set associated with the purchase or the buyer, offering various purchase options by the seller, selecting a payment option by the buyer and recording the selected payment option by the seller and associating the payment option with the purchase data set, generating a purchase completion report with the total article billing amount and associated delivery charges and the total billing amount resulting there from for the purchase by the seller which indicates completion of the purchase, establishing a connection with an internal accounting unit of the seller or to an external online payment system of the buyer and transmitting at least the total invoice amount, capturing a payment confirmation of the internal accounting unit or of the external online payment system and associating it with the purchase data set and labelling the purchase data set as completed.

### BRIEF SUMMARY OF THE INVENTION

It is an object of the invention to provide an additional option to supply potential buyers with information, advantageously information that can be individualized with respect to a product using a commercial message, direct the buyer to a particular web presence of a seller in order to execute a purchase and to tie the buyer to an online sales platform or an internet stop, to an online marketing platform and/or an online payment system.

The object is achieved according to the invention by a method for executing a purchase using a computer readable medium on which a computer product with program code devices is stored which includes instructions for controlling a computer system for executing the purchase and by a computer system for an online sales platform or an internet shop for executing a purchase and by a computer system for an online marketing platform with the features of the independent claims. Further advantageous embodiments can be derived from the dependant patent claims.

It is provided according to the invention that the payment options include a sponsored payment option which causes receiving a commercial message of the online marketing platform or which requires using an external online payment system where the customer is registered, wherein the sponsored payment option starts a lottery which automatically determines a bonus for the purchase of the buyer if the buyer wins in that lottery, and wherein the bonus is subtracted from the current purchase or from a subsequent purchase or reimbursed in some manner. The bonus is the entire purchase price or a portion thereof, advantageously a percentage thereof. This requires an internet connectable device having computer functionality which is configured to establish a connection with an online marketing platform, advantageously for receiving commercial messages stored in a data base, advantageously a video commercial message and/or with the online sales platform or the internet shop of the buyer. The distribution of a commercial message is advantageously performed by an operator of the online operating platform, alternatively by the seller. For this the distributor, typically the online marketing platform receives a fee from the provider of the commercial message. A portion of the fee is used to pay for the obtainable bonus, advantageously the entire shopping cart. Alternatively the external online payment system can also sponsor the purchase itself through an integrated lottery, wherein also the distribution of commercial messages from a data base of the online payment system and/or an online marketing platform can be included. It is only possible to participate in the lottery after the purchase is completed. Participation in the lottery requires a transfer of the total invoice amount to the online marketing platform by the buyer and the lottery does not start without this transfer so that no unjustified bonus can be achieved. When paying for the purchase through an online payment system the entire invoice amount is transferred so that there is proof of completion of the purchase.

In advantageous embodiments of the method according to the invention described supra the amount of the bonus is determined by the total article billing amount of the purchase, wherein the amount of the bonus advantageously corresponds to the total billing amount, thus the winning probability of the lottery depends on the magnitude of the total article billing amount of the purchase, wherein in particular the winning probability in the lottery decreases with increasing article billing amount. Advantageously the lottery is played on the online marketing platform and a bonus that was won is reported to the buyer, the seller and/or the online payment system of the buyer, wherein the result of lottery and optionally the obtained bonus is advantageously reported together with an online link to an offer of the seller advertising with the commercial message by the online marketing platform or by the online payment system to an offer of another advertiser. It can furthermore be provided that a registration of the buyer is required with the online marketing platform and/or the seller in order to obtain the bonus after winning the lottery. In any case an identification input of the buyer is required in order to be identified by the seller at least after selecting the payment option which records the buyer and associates the buyer with the purchase data set.

One or plural commercial messages of the online marketing platform can be received before the purchase according to an embodiment of the invention, wherein one of plural conformation codes are stored on the computer device that is connected with the internet thereafter. The at least one stored conformation code proves that at least one commercial message of the online marketing platform was displayed to the buyer at the cash register after selecting a payment option provided for the purchase by the seller the stored conformation code can be transferred from the computer device to the internal accounting unit of the seller and/or to the online marketing platform when selecting the sponsored payment option. This variant is advantageously adapted to a purchase in a normal store which is physically entered by the buyer. Thus, the internal accounting unit of the seller transfers the total billing amount, this means the purchase price to be payed from the internal accounting unit of the seller directly or through the computer device indirectly to the online marketing platform and the lottery is started thereafter. The result of the lottery is reported to the buyer and/or the seller. When the lottery is won the win is reported to the buyer and/or the internal accounting unit of the seller and the purchase price is covered in its entirety. This can be performed in that the bonus is either immediately subtracted from the current purchase by the accounting unit of the seller, credited to the online marketing platform, or subsequently reimbursed to the buyer in a suitable manner.

The commercial message of the online marketing platform with the subsequent lottery can be received in another embodiment of the invention after the purchase within the deadline determined by the online marketing platform within the predetermined deadline and the lottery can be played, wherein the buyer is reimbursed the entire article billing amount when he wins the lottery. The granted bonus can include the delivery cost. Thus, the bonus, advantageously the entire article billing amount can be credited to the buyer as cash in the account of the online payment system used or it can be transmitted as a coupon. Alternatively the dollar amount can also be reimbursed directly to the bank account of the buyer. Otherwise the dollar amount can also be credited to an account of the buyer that is registered with the seller. In order to select commercial messages the articles included in the purchase data base of the current purchase can be transmitted to the online marketing platform and/or prior purchases can be used as a basis for a buyer who is already registered with the online marketing platform.

The invention furthermore relates to a computer readable medium on which a computer program product is stored which includes program code devices which include instructions for controlling a computer system in order to control and coordinate and execution of a purchase of a buyer from a seller, wherein the purchased articles are stored in an electronic data base of the seller with an article data set and an article price on a computer device, wherein the method includes the following steps.

Selecting at least one article offered by the seller, recording the at least one article selected by the buyer, recording a purchase completion report indicating completion of the purchase, at least temporary storing of an article data set associated with the at least one selected article with the article price and the resulting total article billing amount for the purchased articles in a purchased data set associated with the purchase, offering plural payment options through the seller, selecting a payment option through the buyer and capturing the selected payment option through the seller and associating it with the purchase data set, generating a purchase completion report with the total article billing amount and optionally delivery cost and a resultant total billing amount for the purchase by the seller which indicates completion of the purchase, establishing a connection to an internal accounting unit of the seller or to an external payment system of the buyer and transmitting at least the total invoice amount, capturing a payment information of the internal accounting unit or of the external online payment system and associating it with the purchase data set and marking the purchase data set as completed.

According to the invention the computer program product stored on the computer readable medium includes program code devices where the payment options include a sponsored payment option which causes a reception of commercial message of the online marketing platform or requires using an external online payment system in which the buyer is registered as a customer, wherein the sponsored payment option includes a lottery which is being started, wherein the lottery automatically determines a bonus for the purchase of the buyer when the lottery is won, wherein the bonus is credited towards the current purchase or towards a subsequent purchase or is being reimbursed. For the purchase a device is required that is connectable with the internet and includes computer functionality wherein a connection to an online marketing platform is generatable, advantageously for receiving a commercial message that is stored in a data base, advantageously a video commercial message wherein the connection is establishable to the online sales platform of the buyer and/or the an online payment system for executing the payment. The program code devices of the computer code product are transferrable to the computer device of the internet shop and/or the server of the online marketing platform. The computer readable medium on which the program code devices are stored can be for example be compact disk (CD) and flash memory card, a USB stick, a hard drive (HD, SSD, SSHD) or similar.

Thus, depending on the variant of the method according the invention described supra for executing a purchase of a buyer from a seller, wherein the articles of the purchase are stored in an electronic data base of the seller with an article data set and an article price on a computer device and depending on granting a bonus for the executed purchase using the internet for accessing the lottery of the online marketing system or of the online payment system different versions are provided of the computer program product according to the invention wherein the versions differ in particular through a portion of the program code devices which are storable on a computer readable medium and which include instruction for controlling a computer system to control the execution of the purchase of the buyer from a seller. The different program code devices consider all embodiments of the sales execution methods described supra between a buyer which uses a device that is connectable with the internet and includes computer functionality in order to establish a connection with an online marketing platform, advantageously for receiving a commercial message stored in a data base of an online marketing platform which facilitates a bonus for the respective purchase which depends from the commercial message being transmitted to the buyer and/or wherein the buyer uses his internet capable device having computer functionality in order to establish a connection to an online payment system for executing the payment for the purchase performed wherein the online payment system facilitates a bonus for the respective purchase advantageously through a lottery that is not dependent from a transmission of commercial message to the buyer. The computer readable medium according to the invention includes a variant or different variants of different program code devices which are respectively associated with one or plural variants of the method according to the invention for executing a purchase of a buyer from a seller. A portion of the program code devices can be optionally provided to be transmitted to the computer device through the internet in order to facilitate or simplify communications of the buyer with the internet shop or the online marketing platform as user software, e.g. configured as an app.

The invention also relates to a computer system for an online sales platform, advantageously an internet shop for executing a purchase of a buyer from a seller, wherein an internet connection is established or can be established through the selling system to an online marketing platform for receiving online messages stored in a data base wherein the commercial messages are received on a computer device of the buyer that is connectable with the internet and/or to an online payment system of the buyer for payment execution and is loaded into the computer unit of the online marketing platform or of the online payment system the program code devices of the previously described computer program product are introduced in order to facilitate the method according to the invention for sales execution with all its preferred embodiments.

The invention furthermore also relates to a computer system for an online marketing platform which is configured to direct potential customers to a particular internet presence for executing a purchase from a seller, wherein a network connection to an online sales platforms is establishable through the online marketing platform wherein the online sales platform is advantageously an internet shop of a seller, an online payment system of the customer for payment execution and/or a computer device of the buyer that is connected or connectable with the internet in order to transmit receipt of a commercial message stored in a data base of the online marketing platform to the buyer, wherein the program code devices of the computer program code product of the invention described supra are stored on a server of the online marketing platform or the online payment system into the computer device in order to facilitate the sales execution method according to the invention with all provided embodiments.

The invention has great advantages for the buyer, the seller and the online marketing platform. The added value for the buyer is that he has a chance that the entire billing amount for his purchase is covered by the lottery, thus he can shop for free in case he wins. The added value for the seller is that he can entice more customers with this free shopping chance and can thus achieve increased sales. The added value for the online marketing platform is in achieving an increased adverting effect since it has to be expected that the commercial messages are viewed at a much higher abort percentage than usual due to the winning option.

In conclusion the invention generally relates to providing and using sponsored payment options wherein participating in the lottery provided either requires completely viewing a transmitted commercial message or optionally requires viewing the commercial message or does not require viewing the commercial message at all. The sponsored checkout with the perquisite that the lottery starts only when a commercial message has been viewed before in its entirety can be used in a regular internet shop, in an internet shop with an integrated online payment system which maybe coupled with the internet shop, in a regular store or in a store with an internal payment system or an externally provided online payment system. A sponsored checkout without obligation to receive a commercial message before the lottery can be used in an internet shop with an integrated payment system or with a payment system coupled with the internet shop, in a regular store or in a store with an internal payment system or an externally provided online payment system. The invention also includes the case where the seller and/or the online payment system operates an online marketing platform of its own which facilitates transmitting commercial messages to a buyer through the internet in a controlled manner.

### BRIEF DESCRIPTION OF THE DRAWINGS

The invention is subsequently described based on an embodiment with reference to drawing figures. Additional features of the invention can be derived from the following description of embodiments in combination with the claims and the appended drawing figures, wherein:

FIG. 1 illustrates a sales execution according to the invention from a beginning of a purchase process to an end of the purchase process in ten steps;

FIG. 2 illustrates a use of the sponsored payment option in a store in general;

FIG. 3 illustrates the use of the sponsored payment option in an internet shop in general;

FIGS. 4a, b, c illustrate different payment options in a sponsored internet shop;

FIGS. 5a, b illustrates different payment options in a physical store; and

FIG. 6 illustrates a computer system for an online marketing system that is network connected with a computer system for an online sales platform, in particular an internet shop.

### DETAILED DESCRIPTION OF THE INVENTION

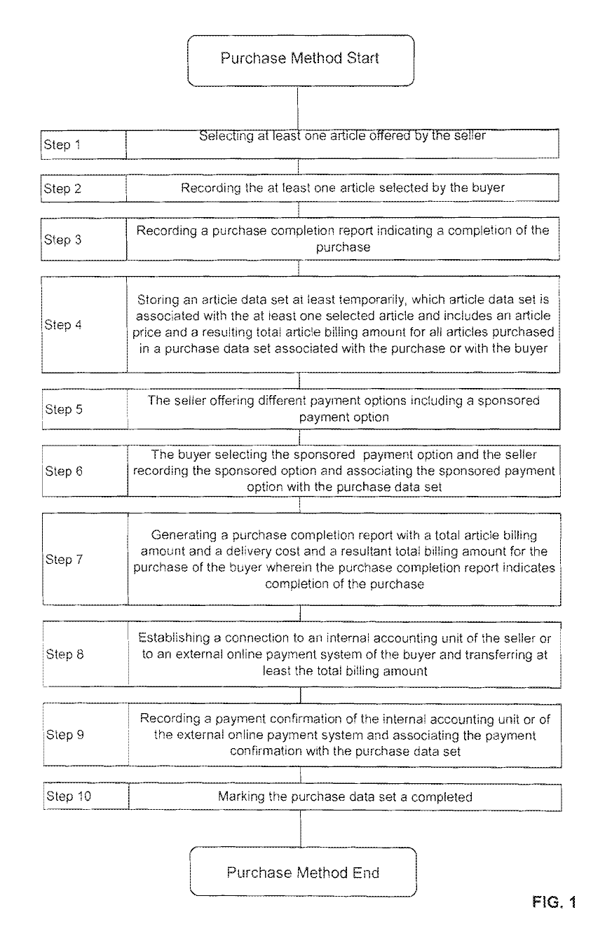

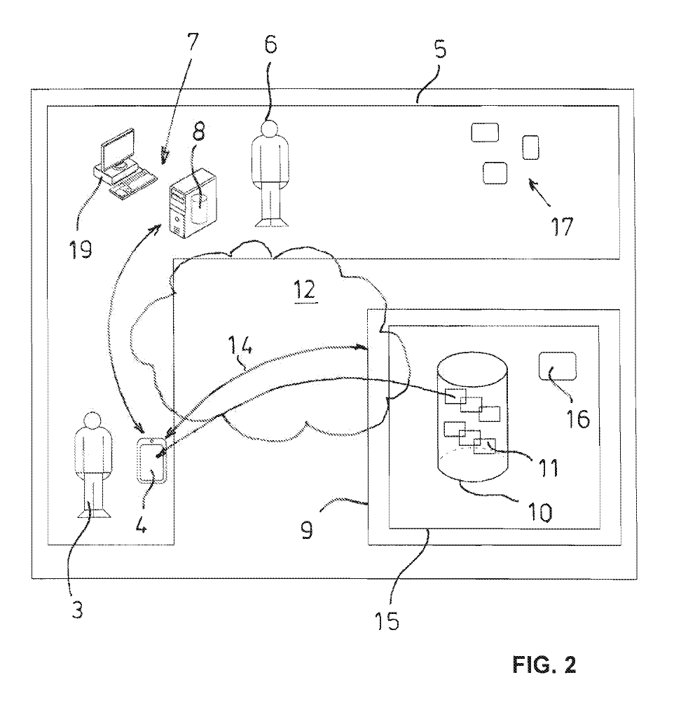

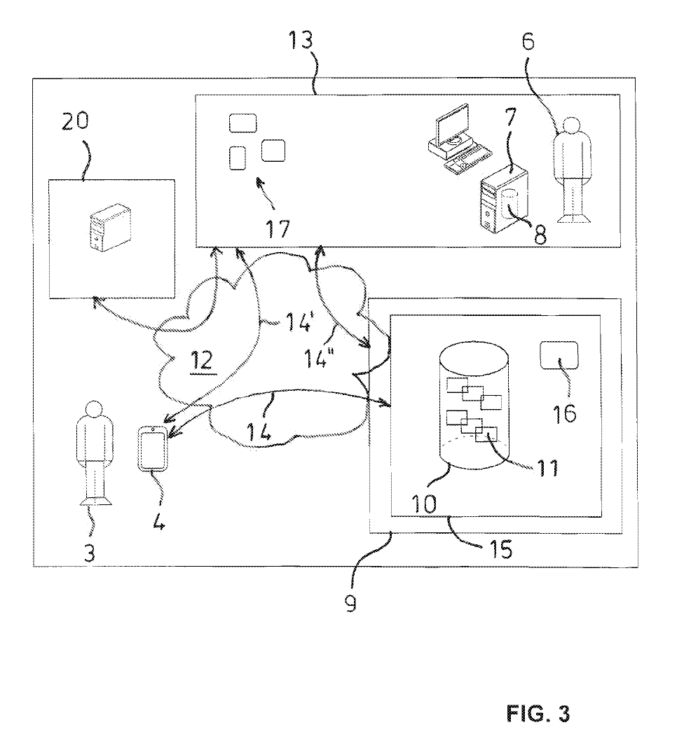

The instant invention relates to a method for executing a purchase of a buyer from a seller in a physical store or via e-commerce, wherein the articles offered for purchase are stored in an electronic data base of the seller with an article data base and a price on a computer unit of the store or of the internet shop. The reference numerals from FIGS. 2 and 3 are subsequently used in the description of FIGS. 1, 4a through 4c, 5a, 5b, and 6.

FIG. 1 illustrates a flow chart of a sales execution 1 according to the invention with ten method steps which are executed by a respective buyer 6 from a beginning of a purchase until the purchase is completed, wherein most of the steps are typical method steps of a sales execution. Based on the invention the steps 5, 6, and 7 differ from method steps that are otherwise being used at these stages of sales execution. These method steps in a store 5 and also in an internet shop 13 include selecting at least one article 7 offered by the seller 6 (step 1), recording the at least one article 17 selected by the buyer 3 (step 2), recording a purchase completion report indicating completion of the purchase (step 3), at least temporary storing of an article data set associated with the at least one selected article 17 with an article price and a total article billing amount for the purchase in a purchase data set associated with the purchase or with the buyer (step 4), offering different payment options 18 by the seller 6 including a sponsored payment option (step 5), selecting the sponsored payment option by the buyer 6 and recording the selected payment option by the seller 6 and associating it with the purchase data set (step 6), generating a purchase completion report including the total article billing amount and optionally delivery cost in consideration of at bonus that is obtained or obtainable in a provided lottery and a total billing amount resulting there from through the seller 6 which indicates completion of the purchase to the buyer 3 (step 7), establishing a connection to an internal accounting unit 19 of the seller 6 or to an external online payment system 20 of the buyer 3 and transmitting at least the entire billing amount which is calculated as a sum of the entire article billing amount and optionally the delivery cost (step 8), recording a payment conformation of the internal accounting unit 19 or of the external online payment system 20 and associating the payment confirmation with the purchase data set (step 9), and characterizing the purchase data set as completed (step 10).

Thus, it is provided that the buyer 3 can establish a connection to the internet 12 with an internet connectable computer device 4, for example a smart phone, a tablet computer, a laptop, or a personal computer for receiving commercial messages 11 stored in an electronic data base 10 of an online marketing platform. Establishing this connection is not required for all embodiments of the invention. It is provided according to the invention that a sponsored payment option 18′ is included into the payment options 16 offered by the seller 6, wherein the sponsored payment option causes receiving a commercial message 11, advantageously a commercial video message of the online marketing platform 9 or using an external online payment system 20 is required for paying for the purchase wherein the buyer 3 is registered at the external online payment system 20. A lottery 16 is integrated in the sponsored payment option 18′, wherein the lottery automatically determines a bonus for the buyer 3 in case the lottery is won, wherein the bonus in the form of covering the entire billing amount of the buyer or a percentage thereof, for example 50% of the billing amount is credited towards the current purchase or a subsequent purchase or reimbursed. In case receiving the commercial message is required the lottery 16 only starts after receiving the entire commercial message 11, wherein the lottery 16 can be started automatically when paying for the purchase through the external online payment system 20 simply by logging on to the online payment system 20 FIGS. 2 and 3 schematically illustrate the communication between the buyer, the seller, and the online marketing platform 9 through the internet 12 for a store (FIG. 2) and in an internet shop 13 (FIG. 3).

FIG. 2 illustrates a purchase in a store 5. The store 5 is provided with a computer unit 7 which connected with a non illustrated electronic cash register system. The computer unit 7 provides an electronic data base 8 and an internal accounting unit 19 on which articles 17 that are offered for sale are stored with an article data set and the article price. The cash register system can access the data base 8 of the computer unit 7 and the internal accounting unit 19. The seller 6 and the buyer 3 are physically present in the store 5. The buyer 3 has a computer device 4 which is connectable with the internet 12 and establishes a connection 14 with the online marketing platform at the latest in step 5 or 6 of the sales execution 1 wherein the buyer has received a commercial message 11 already before the purchase through the internet connection 14 wherein the commercial message is stored in a data base 10 of the online marketing platform 9 and wherein the buyer has received a conformation code for receiving the commercial message wherein the confirmation code was stored on the internal capable device 4. By transmitting the confirmation code to the internal accounting unit 19 and transferring the purchase price to the computer device 4 and/or to the online marketing platform 9 a lottery 16 is automatically started during sales execution on a server 15 of the online marketing platform 9 wherein the lottery automatically determines a bonus for the purchase of the buyer 3 in case the lottery is won. After the lottery 6 the buyer 3 is informed by the online marketing platform 9 regarding the result of the lottery and an obtained bonus with a report to his computer device 4, in particular an amount of the bonus for the purchase performed is reported by the online marketing platform 9 to the buyer 3.

The obtained bonus is transmitted to the buyer advantageously together with an online link to the offering of the party adverting with the commercial message by the online marketing platform 9. The purchase price and the confirmation code are transmitted wirelessly between the computer device 4 and the internal accounting unit 19 of the seller 6 when the sponsored payment option is selected. This is advantageously performed by an electronic transmission system which has a radio or optical interface with the cash register system of the seller 6.

Advantageously near field communication (NFC) is used for this purpose. This is an international transmission standard for contactless data exchange over short distances of a few centimetres. When the sponsored payment option is not selected the confirmation code can be used during a subsequent purchase. Using the confirmation code is reported to the online marketing platform 9 through the internet 12. The number of confirmation codes stored on the computer device 4 is a function of the number of the commercial messages 11 received and viewed before the purchase. The number of confirmation codes received can certainly be increased by receiving and viewing commercial messages 11.

FIG. 3 visualizes a purchase in an internet shop 13. The internet shop 13 is associated with a seller 6 and also includes a computer unit 7 which provides a data base 8 of the seller 6 in which the articles 17 that are offered for sale are stored with an article data set and an article price. The customer 3 virtually enters the internet shop 13 with the computer device 4 that is connectable with the internet 12 in that he establishes a connection 14′ with the internet 12 to the computer unit 7 of the seller 6. At the internet shop the buyer places at least one article 17 into a virtual shopping cart. In step 5 of the sales execution 1 when different payment options 18 are offered by the seller 6 the buyer 3 can select between the conventional payment options 18 and the sponsored payment option 18′. When the buyer 6 selects the sponsored payment option 18′ he may be able to obtain a bonus for his purchase. When executing the sponsored payment option 18′ the seller 6 establishes a connection 14′ through the internet 12 to the online marketing platform 9 which has a plurality of commercial messages 11 stored in an electronic data base 10 of the server 15. After selecting and transmitting at least one commercial 11 on to the computer device 4 and completely viewing the commercial message 11 by the buyer 3 a respective lottery 16 is started on the server 15 wherein the lottery automatically determines a possible bonus for the purchase performed. There is also an option to receive the commercial message 11 only after completing the purchase process with in a dead line set by the online marketing platform 9. Accordingly the lottery 16 only starts thereafter. After completing the lottery 16 the amount of a bonus 1 is automatically transmitted to the buyer 3 and or the seller 6 if there is any bonus at all. The message to the buyer 3 optionally includes an online link to the offer of the party advertising with the commercial message 11. In the physical store 5 and also in the internet shop 13 a bonus that is won can be credited towards the current purchase or a subsequent purchase or it can be payed out. Crediting is advantageously provided when buying in the internet shop 13. Thus the amount of the bonus is in both cases determined based on the total article billing amount, wherein the amount of the bonus advantageously corresponds to the total billing amount of the purchase or a percentage thereof. Thus the bonus that is obtainable in the lottery can be used as a credit against the current purchase or as a cash coupon or as a product coupon. The wining probability in the lottery 6 is advantageously a function of amount of the total billing amount of the purchase, wherein the success probability decreases with increasing total article billing amount. In case the lottery does not lead to the bonus of the type recited supra a discount in the billing amount, reduced cost delivery or free delivery bonus point allocation or a promotional product.

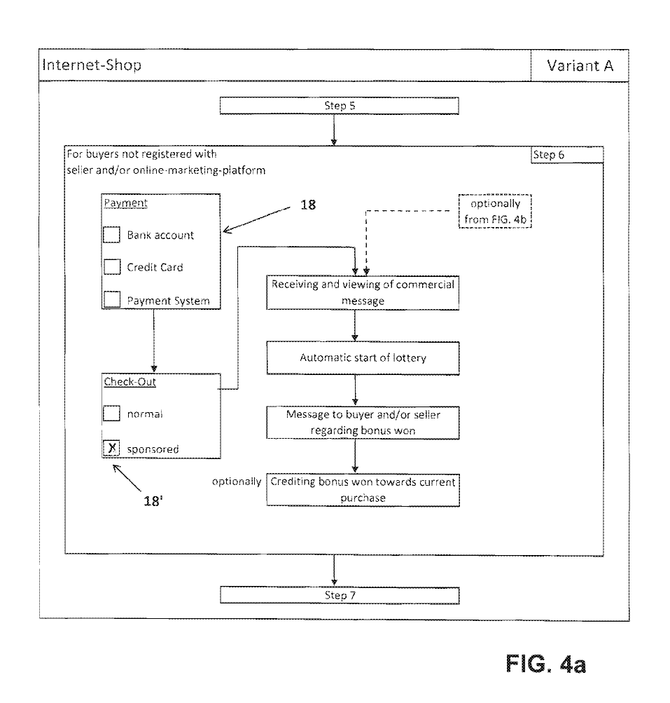

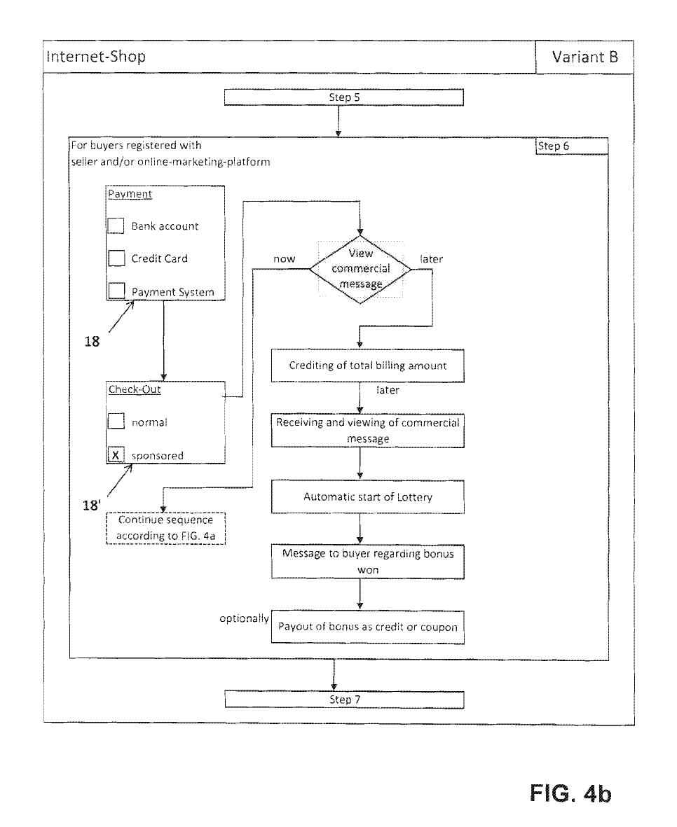

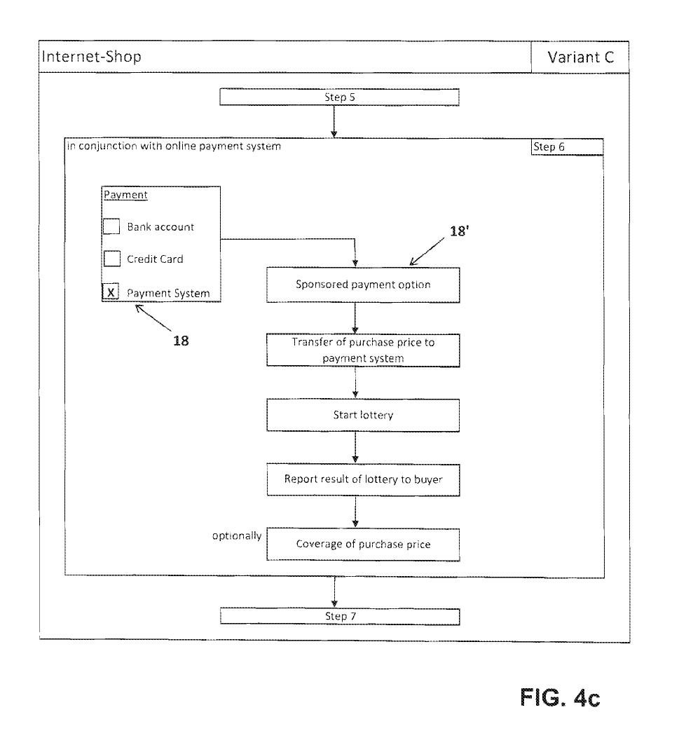

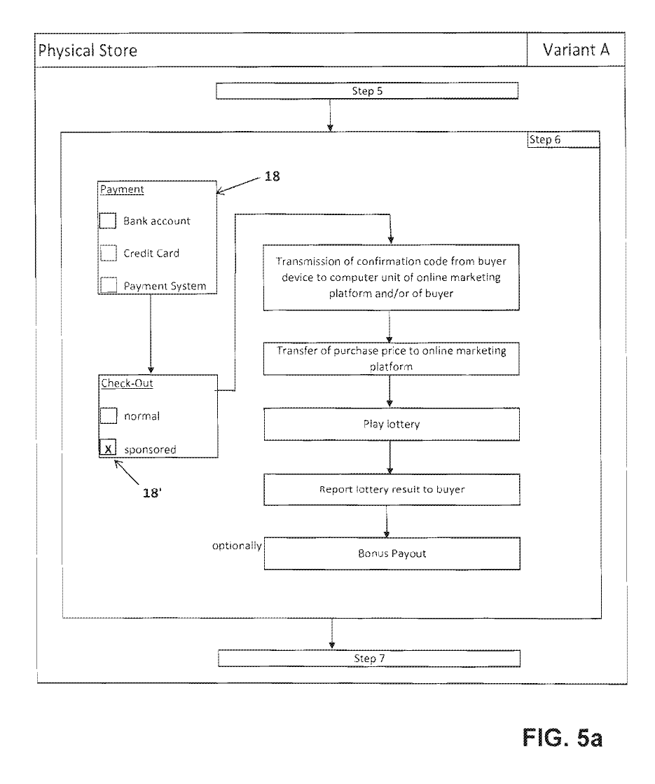

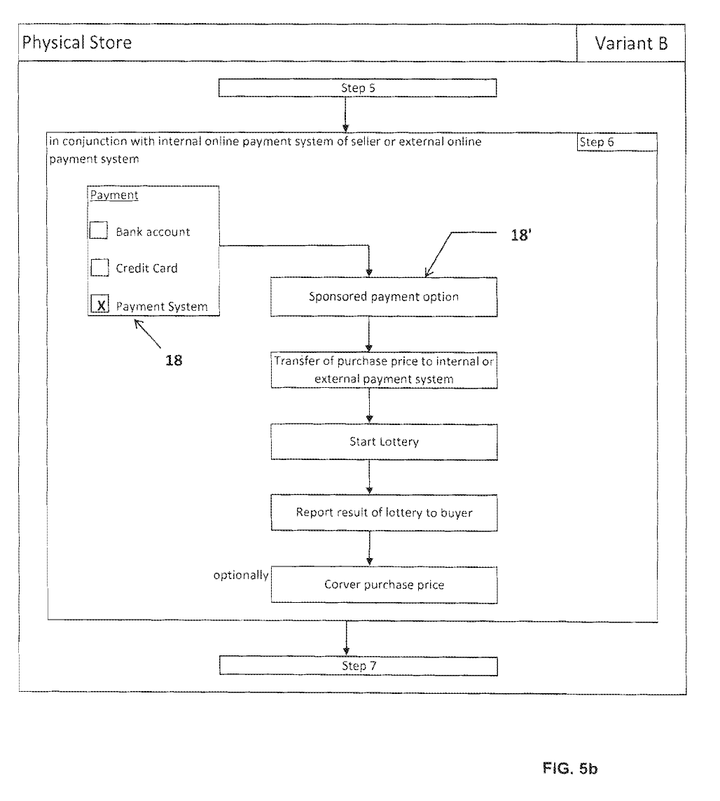

FIGS. 4 and 5 show step 6 of the sales execution 1 with different payment options in an internet store (FIGS. 4a through 4e) and in a store 5 (FIGS. 5a and 5b). FIG. 4a illustrates a typical procedure for a buyer that is not registered in the internet shop 13 and/or at the online marketing platform 9, this means for a guest customer and FIG. 4b illustrates a typical process for a customer registered in the internet shop 13 and/or with the online marketing platform 9, this means for registered customer, wherein the reception of the at least one commercial message 11 before, during, or after the purchase is a prerequisite for participating in the lottery 16 through which a bonus for the purchase performed maybe obtainable. FIG. 4c illustrates a typical sequence for a buyer registered in the internet shop 13 and/or with the online marketing platform 9, wherein receiving a commercial message 11 is not mandatory for participating in the lottery 16. FIG. 5a illustrates a typical process for a buyer 3 which makes a purchase in a conventional store 5 wherein the buyer is not registered in the conventional store 5 and may not be registered with the online marketing platform 9 or is registered with the online marketing platform 9. FIG. 5b illustrates a process where the seller 6 has arranged for payment for the purchase through an internal online payment system or through an external online payment system, wherein the buyer 3 is registered in the store 5 and/or with the online marketing platform 9.

FIG. 4a illustrates the conventional payment option 18 as variant a e.g. with a credit card of a credit card institute, a bank card of a bank with an associated checking account, an online payment system which typically takes over a full payment and optionally reimbursement guarantee and the sponsored payment option 18′ which is provided by the invention as “sponsored checkout”. The payment options 18 or 18′ are being offered to the buyer 3 in step 5 of the purchase execution 1 illustrated in FIG. 1. In the subsequent step 6 the customer 3 initially selects one of the conventional payment options 18 recited supra in an exemplary manner and there after the customer either decides for a “normal checkout” which continues without the lottery or for the “sponsored checkout” with the lottery provided. When the customer 3 selects the payment option “sponsored checkout” the payment option is recorded by the seller 6 and associated with the purchase data set of the current purchase and thus with the buyer 3. Simultaneously the seller 6 establishes a connection 14 through the internet 12 through the server 10 in the online marketing platform 9, wherein information regarding the articles virtually placed into the shopping cart by the buyer 3 during the purchase are transmitted. Based on the transmitted shopping cart a respective commercial message 11 is selected and transmitted to the seller 6 and through the seller to the buyer 3 or directly to the buyer 3. Alternatively the commercial message 11 can also be random selected. e.g. when a content of the shopping cart cannot be transmitted. After viewing the commercial message 11 by the viewer 3, advantageously a video commercial message the lottery 16 is immediately started on the server 15 of the online marketing platform 9, wherein after running the lottery 16 a message is sent to the seller 6 and/or the buyer 3 on the computer device 4 wherein the message reports the result of the lottery 16 advantageously together with an online link to an offering of the party advertising through the commercial message. This variant A is provided for buyers 3 that are not registered with the seller 6 or with the online marketing platform 9. During a “normal checkout” the buyer 3 omits the transmission of the commercial message and therefore does not participate in the lottery 16. During the sponsored check out however there is the chance for the buyer to obtain a bonus for the purchase through the lottery 16, advantageously to have the entire purchase reimburse. FIG. 4b illustrates another payment option 18, 18′, especially for an already registered buyer 3. This buyer has the same choices with respect to payment options in the variant B illustrated in FIG. 4b like in the variant A described in FIG. 4a. When the buyer selects the “sponsored checkout” he has the option to view the commercial message 11 immediately or later. Accordingly the lottery 16 is started after transmitting and viewing the message 11. When the commercial message 11 with the subsequent lottery 16 is view immediately the potentially one bonus can be credited towards the instant purchase, this means the billing amount can be covered. When the commercial message 11 is only viewed later the bonus from the lottery 16 can certainly not be credited towards the current purchase. Instead the bonus is then provided for example as a cash coupon or product coupon which can be redeemed later or which is reimburse to a bank account of the buyer 3. In any case if the buyer is only registered with an internet shop 13 of the seller 6 he is encouraged to register additionally with the online marketing platform 9. Thereafter like in the variant A step 7 of the sales execution 1 is performed in which a sales completion report with an overall billing amount is generated by the seller 6 and communicated to the buyer 3 which indicates completion of the purchase. A possible bonus is already considered. Certainly also in this case information regarding the purchased articles is transmitted to the online marketing platform 9 wherein a respective commercial message 11 can be selected for the buyer 3 based on the information.

FIG. 4c illustrates a third variant C where the buyer 3 is registered with the internet shop 13 with the seller 6 and/or the online marketing platform 9. The payment runs in this case exclusively through the online payment system 20 where the buyer 3 is also registered. Thus the sponsored payment option with the integrated lottery is provided as standard. The buyer 3 does not have to choose between a regular “normal checkout” where no bonus is provided and a “sponsored checkout” where a bonus is obtainable which can be granted as covering the billing amount. The lottery is automatically started when the customer 3 is referred to the online payment system 20, wherein the bonus cannot be influenced by the buyer 3. The transmission of a commercial message 11 can be provided in this case, wherein the online marketing platform 9 then reimburses the online payment system 20 for distributing the commercial message 11 like to the sellers 6 in internet shops 13. The computer unit 7 of the seller 6 forwards information regarding the purchased article 17 to the online payment system 20 also in this case wherein the online payment system 20 based on this information selects, causes, or sends a commercial message for transmission to the buyer 3 from the data base 10 of the online marketing platform 6, a preparatory data base or another data base with stored commercial messages 11. The bonus granted by the online payment system 20 is directly applied to the current purchase of the buyer 3. Thereafter sales execution 1 is continued with step 7 as usual.

In FIG. 5a the process is illustrated for a buyer 3 that shops in a store wherein the buyer 3 is neither registered in the store 5 nor with the online marketing platform 9. In this figure the conventional payment options 18 for a normal store 5 are illustrated. Already at an earlier point in time, this means before payment in the store the buyer 3 has received and viewed at least one commercial message 11, for example a video commercial message of the online marketing platform 9. After viewing the commercial video message the lottery 16 was not started at this point in time since the lottery depends from the purchase amount but instead a confirmation code was transmitted to the computer device 4 that is connectable with the internet and stored therein. Before the purchase completion report the buyer 3 can then select between various payment options, for example cash payment, debit card payment, credit card payment for the purchase performed. For all these options transmitting the stored confirmation code from the computer device 4 to the computer unit 7 of the store 5 of the seller 6 is optionally provided. The confirmation code is thus transmitted to the internal accounting unit 19 of the seller 6 which transfers the purchase price directly or indirectly through the internet capable device 4 to the online marketing platform 9 so that the lottery 16 can be started there. Simultaneously optional information is transmitted to the online marketing platform 9 regarding the purchase performed through the internet 12 and the confirmation code on the device 4 is deleted. In this case the purchase price is reimburse to the buyer 3 later this however has the effect that the buyer 3 in case he has not registered with the online marketing platform 9 earlier gets this done now. In this case the bonus can also be transferred to a bank account of the buyer 3 registered with the online marketing platform or it can be reimburse in another way. This way the buyer 3 immediately gets a message transmitted to the device 4 wherein the message informs him the result of the lottery.

FIG. 5b illustrates a process where the seller 6 has provided using an internal or external online payment system, wherein the buyer 3 is registered in the store 5, at the online payment system 20 and/or at the online marketing platform 9. The process thus substantially corresponds to the process that is described for the online shop 13 in variant C illustrated in FIG. 4c. Also in this case payment exclusively runs through the online payment system 20. Also here the sponsored payment option with the integrated lottery is provided as a standard so that the buyer 3 does not have to make a choice between a “normal checkout” and a “sponsored checkout”. The lottery starts automatically when selecting the online payment system 20. The computer unit 7 of the buyer 6 forwards information regarding the purchased article 17 to the online payment system 20 also here when using the external online payment system 20 wherein the online payment system 20 based on this information from the data base 10 of the online marketing platform 9, optionally of a data base with sponsored commercial messages 11 optionally selects, causes or executes a respective commercial message 11 for transmission to the buyer 3. When using an internal online payment system 20 forwarding this information is not necessary since the internal online payment system 20 has this information so that it can select a commercial message 11 for transmission to the buyer 3 on this basis from the data base 10 of the online marketing platform 9, a preparatory data base or another data base with stored commercial messages 11. The bonus granted by the online payment system 20 is always credited towards the current purchase of the buyer 3. Subsequently the sales execution 1 is continued with step 7 as usual.

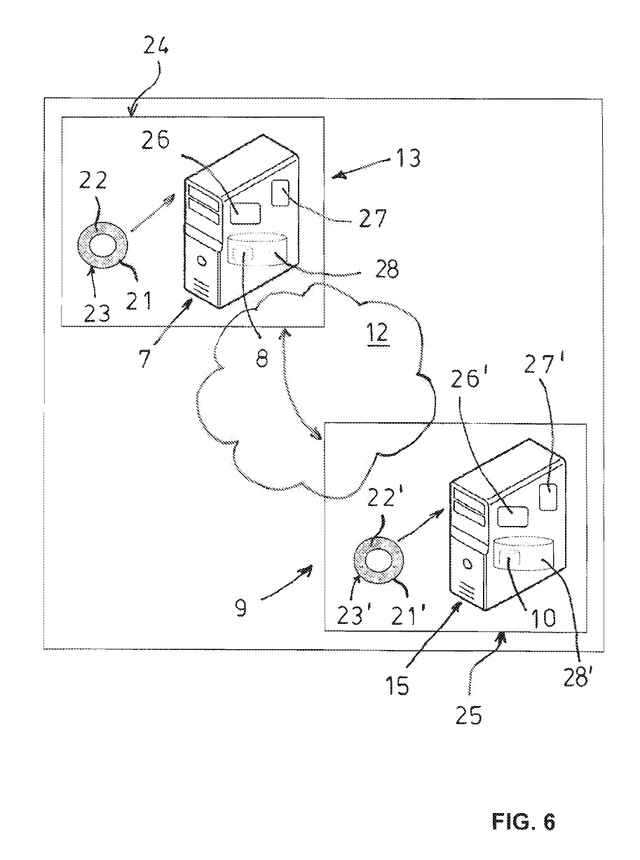

FIG. 6 illustrates a computer system 24 according to the invention for an online sales platform (internet shop) 13 and a computer system 25 according to the invention for an online marketing platform 9 which are networked together or can be networked together and which can exchange data and information with each other with the internet 12. The computer system 24 includes a computer unit 7 with at least one processor 26, with an operating memory 27, and with at least one hard drive 28. The computer system 24 includes a server 15 which also includes at least one processor 26′, an operating memory 27′, and at least one hard drive 28′. The at least one hard drive 28 of the computer unit 7 includes an operating system, at least 1 computer program product 23 for sales execution 1 and at least one data base 8 in which the articles offered for sale are stored with an article data base and an associated article price in which buyers 3 are registered and the purchases of the buyers are managed. The at least one hard drive 28 of the server 15 also includes the operating system, at least one computer program product 23′ for marketing execution, and at least one data base 10 on which commercial messages 11 from advertisers, advantageously video messages are stored and where users of the online marketing platform 9 or buyers 3 of the online marketing platform, advantageously of the internet shop 12 of the seller 3 can register. The computer product 23 for the computer unit 7 of the online sales platform 12 differs from the computer program product of the server 15 of the online marketing platform 9, wherein the computer program product 23 includes program code devices 22 which are stored on a computer readable medium 21 and the computer program product 23′ includes program code devices 22′ which are stored on a computer readable medium 21′. The program code devices 22 of the computer readable medium 21 and the program code 22′ of the computer readable medium 21′ differ from each other and are transferrable to the hard drive 28 or 28′ through suitable electronic reads. The program code devices 21 facilitate for the computer unit 7 to perform sales execution 1 and the buyer 3 and/or with the online payment system through its computer device 4 and communications with the server 7 respectively through the internet 12. The program code devices 21′ facilitate for the server to perform marketing execution with the buyer 3 through the internet 12, either directly or at its computer device 4 and/or through the computer unit 7 of the online sales platform 13. The program code devices 21 or 21′ are loaded from the hard drive 28 or 29′ into the operating memory 27 or 27′ and are executed there by the processor 26 or 26′.

What is claimed is:

1. A method for executing a purchase of a buyer from a seller wherein at least one article of the purchase is stored in an electronic data base of the seller together with an article data set and an article price on a computer unit, the method comprising the steps:
selecting at least one article offered by the seller;
recording the at least one article selected by the buyer;
recording a purchase completion report indicating a completion of the purchase;
storing an article data set at least temporarily, which article data set is associated with the at least one selected article and includes an article price and a resulting total article billing amount for all articles purchased in a purchase data set associated with the purchase or with the buyer;
the seller offering different payment options;
the buyer selecting a payment option and the seller recording the selected payment option and associating the selected payment option with the purchase data set;
generating a purchase completion report with a total article billing amount and a delivery cost and a resultant total billing amount for the purchase of the buyer wherein the purchase completion report indicates completion of the purchase;
establishing a connection to an internal accounting unit of the seller or to an external online payment system of the buyer and transferring at least the total billing amount;
recording a payment confirmation of the internal accounting unit or of the external online payment system and associating the payment confirmation with the purchase data set; and;
marking the purchase data set as completed,
wherein a connection to an online marketing platform is established by an internet connectable computer device for receiving commercial messages stored in a data base or to an online payment system for payment execution,
wherein the payment options include a sponsored payment option which causes a receipt of a commercial message from the online marketing platform or which requires using an external online payment system in which the buyer is registered;
wherein the sponsored payment option includes a lottery which automatically determines a bonus for the purchase of the buyer when the lottery is won, and
wherein the bonus is credited towards the current purchase or towards a subsequent purchase or the bonus is paid out.

2. The method according to claim 1, wherein an amount of the bonus is determined by the total article billing amount for the purchase.

3. The method according to claim 1, wherein the amount of the bonus corresponds to the total billing amount or a percentage of the total billing amount.

4. The method according to claim 1, wherein a wining probability in the lottery is a function of the total article billing amount for the purchase.

5. The method according to claim 4, wherein the winning probability in the lottery decreases with an increase of the total article billing amount.

6. The method according to claim 1,
wherein the lottery is played on the online marketing platform, and
wherein a bonus that is won is reported to the buyer, the seller or the online payment system of the buyer.

7. The method according to claim 6, wherein the bonus that is won is reported to the buyer through an online link to an offer from a party advertising with the commercial message by the online marketing platform or by the online payment system.

8. The method according to claim 1, wherein a registration of the buyer at the online marketing platform is required in order to receive the bonus when the lottery is won.

9. The method according to claim 1, wherein an identification input by the buyer for identifying the buyer to the seller is recorded and associated with the purchase data set after selecting the payment option at the latest.

10. The method according to claim 1, wherein the commercial message of the online marketing platform is received before the purchase and a confirmation code is stored on the computer device that is connected with the internet when the lottery is won.

11. The method according to claim 10, wherein the confirmation code is transmitted from the computer device to the internal accounting unit of the seller and the total article billing amount is transferred from the internal accounting unit of the seller directly or through the computer device indirectly to the online marketing platform when the sponsored payment option is selected and the lottery is started thereafter and the bonus is paid to the buyer when the lottery is won.

12. The method according to claim 1, wherein the commercial message of the online marketing platform with the subsequent lottery is received after the purchase within a deadline that is defined by the online marketing platform and the lottery is played and the bonus is paid to the buyer when the lottery is won.

13. The method according to claim 12, wherein the bonus is credited to the buyer as a cash amount in an account of the online payment system or the bonus is transferred to the buyer as a coupon.

14. The method according to claim 1, wherein articles included in the purchase data set or prior purchases of a buyer that is already registered with the online marketing platform are used as a basis for selecting the commercial messages.

15. The method according to claim 1, wherein the commercial messages are commercial video messages.

16. A computer readable medium on which a computer program product is stored which includes program code devices including instructions for controlling a computer system configured to control and coordinate an execution of a purchase of a buyer from a seller, wherein articles of the purchase are stored in an electronic data base of the seller together with an article data set and an article price on a computer unit using a method comprising the steps:
selecting at least one article offered by the seller;
recording the at least one article selected by the buyer;
recording a purchase completion report indicating a completion of the purchase;
storing an article data set at least temporarily, which article data set is associated with the at least one selected article and includes an article price and a resulting total article billing amount for all articles purchased in a purchase data set associated with the purchase or with the buyer;
the seller offering different payment options;
the buyer selecting a payment option and the seller recording the selected payment option and associating the selected payment option with the purchase data set;
generating a purchase completion report with a total article billing amount and a delivery cost and a resultant total billing amount for the purchase of the buyer wherein the purchase completion report indicates completion of the purchase;
establishing a connection to an internal accounting unit of the seller or to an external online payment system of the buyer and transferring at least the total billing amount;
recording a payment confirmation of the internal accounting unit or of the external online payment system and associating the payment confirmation with the purchase data set; and;
marking the purchase data set a completed,
wherein a connection to an online marketing platform is established by an internet connectable computer device for receiving commercial messages stored in a data base or to an online payment system for payment execution,
wherein the payment options include a sponsored payment option which causes a receipt of a commercial message from the online marketing platform or which requires using an external online payment system in which the buyer is registered;
wherein the sponsored payment option includes a lottery which automatically determines a bonus for the purchase of the buyer when the lottery is won, and
wherein the bonus is credited towards the current purchase or towards a subsequent purchase or the bonus is paid out.

17. The computer readable medium according to claim 16, wherein an amount of the bonus is determined by the total article billing amount for the purchase.

18. The computer readable medium according to claim 16, wherein the amount of the bonus corresponds to the total invoice amount or a percentage of the total invoice amount.

19. The computer readable medium according to claim 16, wherein a wining probability in the lottery is a function of the total article billing amount for the purchase.

20. The computer readable medium according to claim 19, wherein the winning probability in the lottery decreases with an increase of the total article billing amount.

21. The computer readable medium according to claim 16,
wherein the lottery is played on the online marketing platform, and
wherein the bonus that is won is reported to the buyer, the seller or the online payment system of the buyer.

22. The computer readable medium according to claim 21, wherein the bonus that is won is reported to the buyer through an online link to an offer from a party advertising with the commercial message by the online marketing platform or by the online payment system.

23. The computer readable medium according to claim 16, wherein a registration of the buyer at the online marketing platform is required in order to receive the bonus when the lottery is won.

24. The computer readable medium according to claim 16, wherein an identification input by the buyer for identifying the buyer to the seller is recorded and associated with the purchase data set after selecting the payment option at the latest.

25. The computer readable medium according to claim 16, wherein the commercial message of the online marketing platform is received before the purchase and a confirmation code is stored on the computer device that is connected with the internet when the lottery is won.

26. The computer readable medium according to claim 25, wherein the confirmation code is transmitted from the computer device to the internal accounting unit of the seller and the total article billing amount is transferred from the internal accounting unit of the seller directly or through the computer device indirectly to the online marketing platform when the sponsored payment option is selected and the lottery is started thereafter and the bonus is paid to the buyer when the lottery is won.

27. The computer readable medium according to claim 16, wherein the commercial message of the online marketing platform with the subsequent lottery is received after the purchase within a deadline that is defined by the online marketing platform and the lottery is played and the bonus is paid to the buyer when the lottery is won.

28. The computer readable medium according to claim 27, wherein the bonus is credited to the buyer as a cash amount in an account of the online payment system or the bonus is transferred to the buyer as a coupon.

29. The computer readable medium according to claim 16, wherein articles included in the purchase data set or prior purchases of a buyer that is already registered with the online marketing platform are used as a basis for selecting the commercial messages.

30. The computer readable medium according to claim 16, wherein the commercial messages are commercial video messages.

31. A computer system for an online sales platform or an internet shop for executing a purchase of a buyer from a seller,
wherein purchased articles are stored in an electronic data base of the seller with an article data set and an article price on a computer unit,
wherein a network connection exists or is establishable through the online sales platform to an online marketing platform for receiving commercial messages which are stored in a data base, wherein the commercial messages are received in an internet connectable device of the buyer or
wherein a network connection exists or is establishable to an online payment system for payment execution, and
wherein the computer unit is uploaded with program code devices of a computer program product which includes program code devices including instructions for controlling a computer system configured to control and coordinate an execution of a purchase of a buyer from a seller, wherein articles of the purchase are stored in an electronic data base of the seller together with an article data set and an article price on a computer unit using a method comprising the steps:
selecting at least one article offered by the seller;
recording the at least one article selected by the buyer;
recording a purchase completion report indicating a completion of the purchase;
storing an article data set at least temporarily, which article data set is associated with the at least one selected article and includes an article price and a resulting total article billing amount for all articles purchased in a purchase data set associated with the purchase or with the buyer;
the seller offering different payment options;
the buyer selecting a payment option and the seller recording the selected payment option and associating the selected payment option with the purchase data set;
generating a purchase completion report with a total article billing amount and a delivery cost and a resultant total billing amount for the purchase of the buyer wherein the purchase completion report indicates completion of the purchase;
establishing a connection to an internal accounting unit of the seller or to an external online payment system of the buyer and transferring at least the total billing amount;
recording a payment confirmation of the internal accounting unit or of the external online payment system and associating the payment confirmation with the purchase data set; and;
marking the purchase data set a completed,
wherein a connection to an online marketing platform is established by an internet connectable computer device for receiving commercial messages stored in a data base or to an online payment system for payment execution,
wherein the payment options include a sponsored payment option which causes a receipt of a commercial message from the online marketing platform or which requires using an external online payment system in which the buyer is registered;
wherein the sponsored payment option includes a lottery which automatically determines a bonus for the purchase of the buyer when the lottery is won, and
wherein the bonus is credited towards the current purchase or towards a subsequent purchase or the bonus is paid out in order to perform the sales execution method according to claim 1.

32. A computer system for an online marketing platform,
wherein articles of a purchase are stored in an electronic data base of a seller with an article data set and an article price on a computer unit,
wherein the online marketing platform is configured to establish a network connection to a sales system of the seller or to an internet connectable computer device of the buyer or to an online payment system for payment execution to transmit commercial messages to the buyer which commercial messages are stored on a data base of the online marketing platform,
wherein a server of the online marketing platform uploads the program code devices of a computer program product which includes program code devices including instructions for controlling a computer system configured to control and coordinate an execution of a purchase of a buyer from a seller, wherein articles of the purchase are stored in an electronic data base of the seller together with an article data set and an article price on a computer unit using a method comprising the steps:
selecting at least one article offered by the seller;
recording the at least one article selected by the buyer;
recording a purchase completion report indicating a completion of the purchase;
storing an article data set at least temporarily, which article data set is associated with the at least one selected article and includes an article price and a resulting total article billing amount for all articles purchased in a purchase data set associated with the purchase or with the buyer;
the seller offering different payment options;
the buyer selecting a payment option and the seller recording the selected payment option and associating the selected payment option with the purchase data set;
generating a purchase completion report with a total article billing amount and a delivery cost and a resultant total billing amount for the purchase of the buyer wherein the purchase completion report indicates completion of the purchase;
establishing a connection to an internal accounting unit of the seller or to an external online payment system of the buyer and transferring at least the total billing amount;
recording a payment confirmation of the internal accounting unit or of the external online payment system and associating the payment confirmation with the purchase data set; and;
marking the purchase data set a completed,
wherein a connection to an online marketing platform is established by an internet connectable computer device for receiving commercial messages stored in a data base or to an online payment system for payment execution,
wherein the payment options include a sponsored payment option which causes a receipt of a commercial message from the online marketing platform or which requires using an external online payment system in which the buyer is registered;
wherein the sponsored payment option includes a lottery which automatically determines a bonus for the purchase of the buyer when the lottery is won, and
wherein the bonus is credited towards the current purchase or towards a subsequent purchase or the bonus is paid out to the computer unit to perform the sales execution method according to claim 1.

33. A computer system for an online payment system for executing a purchase of a buyer from a seller,
wherein articles of the purchase including an article data set and an article price are stored in an electronic data base of the seller on a computer unit,
wherein a network connection exists or is establishable through the sales system to an online marketing platform for receiving commercial messages stored in a data base on a computer device of the buyer that is connectable with the internet or
with an online payment system for payment execution and
wherein program code devices of a computer program product which includes program code devices including instructions for controlling a computer system configured to control and coordinate an execution of a purchase of a buyer from a seller, wherein articles of the purchase are stored in an electronic data base of the seller together with an article data set and an article price on a computer unit using a method comprising the steps:
selecting at least one article offered by the seller;
recording the at least one article selected by the buyer;
recording a purchase completion report indicating a completion of the purchase;
storing an article data set at least temporarily, which article data set is associated with the at least one selected article and includes an article price and a resulting total article billing amount for all articles purchased in a purchase data set associated with the purchase or with the buyer;
the seller offering different payment options;
the buyer selecting a payment option and the seller recording the selected payment option and associating the selected payment option with the purchase data set;
generating a purchase completion report with a total article billing amount and a delivery cost and a resultant total billing amount for the purchase of the buyer wherein the purchase completion report indicates completion of the purchase;
establishing a connection to an internal accounting unit of the seller or to an external online payment system of the buyer and transferring at least the total billing amount;
recording a payment confirmation of the internal accounting unit or of the external online payment system and associating the payment confirmation with the purchase data set; and;
marking the purchase data set a completed,
wherein a connection to an online marketing platform is established by an internet connectable computer device for receiving commercial messages stored in a data base or to an online payment system for payment execution,
wherein the payment options include a sponsored payment option which causes a receipt of a commercial message from the online marketing platform or which requires using an external online payment system in which the buyer is registered;
wherein the sponsored payment option includes a lottery which automatically determines a bonus for the purchase of the buyer when the lottery is won, and
wherein the bonus is credited towards the current purchase or towards a subsequent purchase or the bonus is paid out are uploaded into the computer unit to perform the sales execution method according to claim 1.

34. A computer program product including program code devices for an online sales platform configured to perform the sales execution method according to claim 1.

35. The computer program product with program code devices for an online marketing platform configured to perform the sales execution method according to claim 1.

36. The computer program product with program code devices for an online payment system configured to perform the sales execution method according to claim 1.

37. A computer program product including program code devices for a computer device that is connectable with the internet through which a connection with an online sales platform, an online marketing platform or an online payment system is establishable to perform the sales execution method according to claim 1.
